(19) United States
(12) Patent Application Publication
(10) Pub. No.: US 2023/0105226 A1
(43) Pub. Date: Apr. 6, 2023

(54) ANTIMICROBIAL FORMULATION COMPRISING METAL NANOPARTICLES OR NANOPARTICLES OF METAL OXIDES SYNTHESISED FROM PLANT EXTRACTS

(71) Applicant: ZUMO TECNOLOGÍA ZUMOTEC S.A, Bucaramanga (CO)

(72) Inventors: Julián Mauricio GUERRERO RODRÍGUEZ, Bucaramanga (CO); José Gabriel LÓPEZ ORTIZ, Bucaramanga (CO); Maria Fernanda ROMERO PINEDA, Bucaramanga (CO); Debora Alcida NABARLATZ, Bucaramanga (CO); Leydy Paola BARRERA LEMUS, Bucaramanga (CO)

(21) Appl. No.: 17/907,201

(22) PCT Filed: Feb. 8, 2022
(86) PCT No.: PCT/IB2022/051132

§ 371 Date: Sep. 23, 2022

(30) Foreign Application Priority Data
Feb. 8, 2021 (CO) NC2021/0001399

(51) Int. Cl. A01N 59/16; A01N 25/30; A01N 25/12; A01P 1/00

(52) U.S. Cl. CPC A01N 59/16; A01N 25/30; A01N 25/12; A01P 1/00

(57) ABSTRACT

The present invention relates to a broad-spectrum biocidal composition, with fungicidal and bactericidal activity, containing metal or metal oxide nanoparticles, polymeric thickeners, plant extracts, surfactants, and additives in an aqueous solvent, as well as the method for in situ production of said metal nanoparticles under controlled operating conditions: concentration, volumetric ratio, time, agitation, temperature, and pH, using plant extracts as reducing agents.

### FIELD OF INVENTION

The present invention is in the field of biotechnology and nanotechnology, specifically in the field of environmentally friendly nanoparticle synthesis methodologies, in addition to the use of these nanoparticles in compositions with biocidal activity, so the present invention is also in the technical field of microorganism control.

### BACKGROUND OF THE INVENTION

In the nanotechnology industry, some routes have been described for the preparation of metallic nanoparticles, one of them is known as top-down, which comprises the reduction of large materials, and the other comprises the construction of metallic nanoparticles from atoms and molecules, called bottom-up.

Top-down routes present disadvantages in terms of homogeneity in particle shape and size, as well as the use of large equipment that generally require high energy consumption. On the other hand, bottom-up routes turn out to be the most viable option to obtain homogeneous and small-sized nanoparticles (Campo Becerra, 2018). These routes allow the chemical synthesis of nanoparticles based on the reduction of ionic species from a metal salt or precursor and a reducing agent and/or stabilizing agent, where the metal salt, considered as the precursor of the reaction, is reduced by the action of the reducing agent to form atoms of the same metal, but with lower valence. These atoms act as small nuclei that agglomerate to form larger molecules, which continue to grow as other atoms continue to be added and this growth stops until the agglomeration of atoms reaches a nanometric level.

In this sense, the control of variables and reaction conditions during the nanoparticle synthesis process such as temperature, pH, solvents, and/or reagents, among others, is a set of critical parameters that can affect the toxicity derived from the use of hazardous reagents, environmental impact, production costs, scalability, final shape, size, particle size distribution, and thus the physical and chemical properties of nanoparticles (Valdez Aguilar, J. 2015).

Alternative strategies aimed at green synthesis of nanoparticles have been studied using phytochemical agents such as plant extracts and/or microbial enzymes, which have properties or compounds that exhibit antioxidant, reducing and/or stabilizing activity. Among the different green methods available are biological, polysaccharide, irradiation Tollens and mixed valence polyoxometalates (M. Ramya & M. Sylvia Subapriya. 2012).

Such synthesis methods provide advantages over chemical and physical methodologies in terms of cost-effectiveness, scalability, use of non-toxic chemical agents, and use of low pressures, temperatures, and reaction energies. Additionally, the matrix of the extracts employed in green synthesis methodologies sometimes acts as a stabilizer, which decreases the aggregation of metal particles without the need to add dispersing agents. Furthermore, the use of various parts of the plant allows the valorization of biomass as it can be considered waste material from other agro-industrial processes or sub-processes (Nadagouda, M. N.; et al., 2010).

In addition, broad-spectrum disinfectants, fungicides, and antibiotics are generally used to control microorganisms. However, their inappropriate use, as well as the ability of microorganisms to develop resistance to chemical agents, has reduced their efficiency (Desselberger, U, 2000). In this sense, the development of novel and efficient antimicrobial agents based on nanotechnology against bacteria and fungi resistant to multiple drugs and disinfectants is one of the priority areas in current research (Rai et al., 2012).

For example, document US20070218555 discloses a formulation with antimicrobial effect containing silver nanoparticles stabilized with an aqueous solution of plant tissue, together with additional excipients such as surfactants, preservatives, rheological agents, polymers, among others. Additionally, this document discloses the method for obtaining said antimicrobial formulation.

Likewise, KR20190072716 discloses a biological method for preparing copper or copper-silver alloy nanoparticles in a colloidal state, using an aqueous plant extract of corn leaf, currant, magnolia and/or turmeric as a reducing agent.

Patent JP2017025383 teaches a metallic nanoparticle composition, particularly of gold, copper, platinum, palladium, or silver and a method for its preparation, wherein said formulation is used as an antibacterial, antiviral, catalytic or coloring agent and employs alcoholic extracts of plants.

Therefore, there is still a need to develop an effective and efficient antimicrobial product with a broad-spectrum biocidal effect to overcome the resistance to microorganisms that characterizes chemical antimicrobial products, as well as reducing the adverse effects that they generate. In addition, it is still a challenge to implement efficient methodologies for obtaining environmentally friendly metallic nanoparticles for applications as bioactive agents.

Thus, the present invention evaluates different extracts from various parts of different plants, with reducing and stabilizing activity for the green synthesis of metallic nanoparticles and their use in a broad-spectrum biocidal formulation.

### BRIEF DESCRIPTION OF THE INVENTION

The present invention relates to a biocidal composition comprising metallic or metal oxide nanoparticles obtained by green synthesis. In said synthesis methodology, which is also the subject of the invention, extracts from different parts of plants are used as reducing and stabilizing agents, water, plant extract, precursor salt, surfactants, and other additives. Due to the composition of this invention, the biocidal effect provided exhibits broad spectrum antimicrobial activity.

In addition, the method for the preparation of said metal or metal oxide nanoparticles is developed which mainly comprises mixing a solution of a first metal salt with an extract of particular plant material under conditions of time, agitation, temperature, and pH, allowing the mixture to stand and taking spectrophotometer readings.

### BRIEF DESCRIPTION OF THE FIGURES

FIG. 1. Characterization of the copper (Cu) nanoparticle solution by Dynamic Light Scattering (DLS). The distribution of particle sizes can be seen. A. Copper-silver nanoparticles from Passiflora ligularis, B. Copper nanoparticles from Solanum betaceum, C. Copper-silver nanoparticles from Cucurbita moschata, D. Iron nanoparticles from Alibertia patinoi, E. Zinc nanoparticles from Selenicereus megalanthus.

### DETAILED DESCRIPTION OF THE INVENTION

This invention relates to a biocidal composition comprising metallic or metal oxide nanoparticles obtained by green synthesis. Additionally, the method for making said metallic or metal oxide nanoparticles is described and claimed.

For purposes of interpreting terms used throughout this document, their usual meaning in the technical field should be considered, unless a particular definition is incorporated. In addition, terms used in the singular form shall also include the plural form.

### Composition

The biocidal composition developed herein comprises metal or metal oxide nanoparticles and a plant extract. For the purposes of the present invention, nanoparticles are understood as an agglomeration of metal atoms of a metal reduced by the action of a plant extract but may include other components such as reducing compounds, or not, of the same extract used, conjugated or not with other substances, coming from the reduction of one or several metal salts, and having a size of less than 100 nanometers, preferably between 10 and 80 nm.

Without representing a limitation, the metal of the metal or metal oxide nanoparticles is selected from the group of transition metals, XIII and XIV. Particularly, the metal of the nanoparticles is selected from, but not limited to, titanium, vanadium, chromium, manganese, iron, cobalt, nickel, copper, zinc, yttrium, zirconium, niobium, molybdenum, rhodium, palladium, silver, cadmium, wolfram, iridium, platinum, gold, aluminum, gallium, indium, tin, platinum, silicon and germanium, and mixtures thereof. In a specific embodiment, the metal of the metal or metal oxide nanoparticles is selected from copper, silver, zinc, iron, and copper-silver.

Furthermore, the nanoparticles are in the biocidal composition at a concentration between 0.01 and 30% (w/v), preferably between 0.05% and 5% (w/v) and more preferably between 0.05 and 1% (w/v).

On the other hand, the plant extract is understood as the product resulting from contacting any part of a plant with a solvent, whereby said extract is any of the aqueous or non-aqueous, polar or non-polar components, or derivatives of this process. This extract must be filtered or centrifuged to separate the residue or material and it is the part of the biocidal composition in a concentration between 0.01 and 30% (w/v), preferably between 10 and 25% (w/v).

In a preferred embodiment, the extracts of the present invention are selected from the group comprising, but not limited to, extracts of the plant species Passiflora ligularis (passion fruit), Sambucus mexicana (elderberry), Selenicereus megalanthus (yellow pitahaya), Solanum quitoense (lulo), Annona cherimola (cherimoya), Solanum bataceum (tree tomato), Cucurbita moschata (butternut squash), Luffa aegyptiaca (sponge gourd), Arracacia xanthorrhiza (arracacha), Fragaria ananassa (strawberry), Furcraea andina (fique), Alibertia patinoi (borojo), Pourteria sapota (sapote), Ficus carica (fig tree), Passiflora quadrangularis (grenadine), Vaccinium meridionale (Andean blueberry), Passiflora maliformis (sweet calabash), Bactris gasipaes (peach palm), Cassia grandis (pink shower tree), Vasconcellea pubescens (mountain papaya), Melicoccus bijugatus (mamoncillo), Mammea americana (mamey) or mixtures thereof. More preferably, the extracts of said species are obtained from any part of the plant such as leaves, stems, seeds, flowers, fruits, latex, roots, or peels.

In the biocide formulation developed, plant extracts may be present as reducing agents, stabilizers or as coadjuvants.

The biocidal composition further comprises a polymeric thickener which may be a gel colloid and is selected from, but not limited to, cellulose gels, alginates, agar-agar, carrageenans, pectins, xanthan gum, grenetin and polyvinylpyrrolidone, and wherein the cellulose gels are selected from carboxymethylcellulose, hydropropylcellulose, methylcellulose, hydroxyethylcellulose and hydroxypropylmethylcellulose. In a preferred embodiment, the polymeric thickener is hydroxypropylcellulose. The concentration of the polymeric thickener in the biocidal composition is between 0.05 and 5% (w/v) and preferably between 0.2 and 0.9% (w/v).

The biocidal composition further comprises one or more surfactants, which may be anionic, nonionic, cationic and/or amphoteric and without limitation, are selected from polysorbate 80, polysorbate 20, glutaraldehyde, second generation quaternary ammoniums and sodium lauryl ester sulfate. The one or more surfactants are in a concentration between 0.05 and 30% (w/v) in the biocidal composition, preferably between 3 and 6% (w/v).

The metallic or metal oxide nanoparticles, dry or in solution, are mixed with the extracts to prepare the biocide composition, where other optional elements such as surfactants and polymeric thickeners can be incorporated in a liquid matrix that can be water, methanol, ethanol, glycerol, polyethylene glycol, among others, and their mixtures.

In a preferred embodiment the biocidal composition of the present invention comprises a concentration of metal nanoparticles or metal oxides between 0.01 and 30% (w/v); surfactants between 0.05 and 30% (w/v); polymeric thickener between 0.05 and 5% (w/v); plant extract between 0.01 and 30% (w/v) and additives 0.5 and 2% (w/v), in an aqueous matrix.

The biocidal composition can be in liquid or gel form, which can be applied directly or in dilution with water, ethanol or other solvents and solutions. In addition, the composition has microbiocidal activity against Escherichia coli, Salmonella typhimurium, Staphylococcus aureus, Desulfotomaculum nigrificans, Candida albicans, Aspergillus niger, and Dengue flavivirus, showing an effectiveness greater than 95%.

### Method for In Situ Processing of Nanoparticles

The present development is also directed to the method of in situ preparation of metallic nanoparticles with antimicrobial properties, comprising mixing extracts coming from different parts of plants with reducing/antioxidant power and one or several metallic salts.

Particularly, the method of making the nanoparticles is a green synthesis method wherein the nanoparticles are produced in situ and comprises
a) mixing a polymeric thickener at a concentration between 0.05 and 5% (w/v), a solution of a first metal salt at a concentration between 0.05 M and 10 M and an extract of a plant material at a volumetric ratio of the first metal salt:extract between 2:1 and 10:1, for at least 2 hours, an agitation of at least 800 rpm, at a temperature between 25 and 100° C. and a pH between 4 and 12;
b) letting the mixture of step a) stand for at least 2 hours at room temperature (25° C.) and without stirring;
c) taking readings of the mixture in a spectrophotometer at the end of step b), until the absorbance shows no variation;
wherein the variation is understood as a ±5% change in absorbance at the beginning of the nucleation process, i.e., at the start of stage b).

In a particular embodiment, the plant material of the extract is selected from the group consisting of Passiflora ligularis, Sambucus mexicana, Selenicereus megalanthus, Solanum quitoense, Annona cherimola, Solanum bataceum, Cucurbita moschata, Luffa aegyptiaca, Arracacia xanthorrhiza, Fragaria ananassa, Furcraea andina, Alibertia patinoi, Pourteria sapota, Ficus carica, Passiflora quadrangularis, Vaccinium meridionale, Passiflora maliformis, Bactris gasipaes, Cassia grandis, Vasconcellea pubescens, Melicoccus bijugatus and Mammea americana. Additionally, this plant material undergoes a previous treatment that includes drying in the open air, in a dryer or in a dark room, and its subsequent crushing or grinding to obtain the largest contact surface and, finally, it is sieved. For the extraction of the reducing/antioxidant compounds and the preparation of the extract, the crushed and sieved plant material is mixed with suitable solvents in a predetermined ratio, for a particular time, temperature and/or agitation.

In one embodiment, the polymeric thickener can be a gel colloid and is selected from, without limitation, cellulose gels, alginates, agar-agar, carrageenans, pectins, xanthan gum, grenetin, and polyvinylpyrrolidone, and wherein the cellulose gels are selected from carboxymethylcellulose, hydropropylcellulose, methylcellulose, hydroxyethylcellulose, and hydroxypropylmethylcellulose. In a preferred embodiment, the polymeric thickener is polyvinylpyrrolidone. The concentration of the polymeric thickener in the biocidal composition is between 0.05 and 5% (w/v) and preferably between 0.05 and 0.6% (w/v).

In a preferred embodiment, the solvents used in the preparation of the plant extract are selected from water, methanol, ethanol, propanol, butanol, ethyl acetate, and mixtures thereof, more preferably an aqueous and/or ethanolic extract. The temperature of the extraction process can be between 20° C. and 130° C., preferably between 25° C. and 60° C., and the extraction pH can be between 3 and 10, preferably between 4 and 7.

The plant extract will act as the dissolving, reducing and/or stabilizing agent in the synthesis of the metal nanoparticles.

In another embodiment of the invention, a second metal salt is added into the mixture of step a), wherein a first metal salt can be mixed with the plant extract at a first time, and a second metal salt can be mixed at a second moment after a period of time. In a preferred embodiment, the first and second metal salt can be mixed with the plant material extract simultaneously.

The metal of the first and second metal salt, which is incorporated in solution into the extract, is selected from the group of transition metals, XIII and XIV. Preferably, and without being limiting, said metal may be titanium, vanadium, chromium, manganese, iron, cobalt, nickel, copper, zinc, yttrium, zirconium, niobium, molybdenum, rhodium, palladium, silver, cadmium, wolfram, iridium, platinum, gold, aluminum, gallium, indium, tin, gold, platinum, iridium, silicon, germanium, and mixtures thereof.

Without being restrictive, inorganic salts include sulfates, nitrates, chlorides, chlorides, phosphates, and fluorides, as well as organic salts such as acetates, citrates, oxalates, and propanoates. During the synthesis process, the salts are presented in solution in the form of ions, separating their metallic part from the non-metallic part. A metallic salt for use in any process of the present invention can be a salt of any of the aforementioned metals or mixtures thereof and acts as a precursor agent.

In a preferred embodiment, the solution of the first and/or second metal salt is incorporated in a concentration between 0.05M and 10M, preferably between 0.01M and 1M.

In a preferred embodiment, the extract of a plant material is incorporated in a concentration between 0.5 and 30% (w/v), preferably between 8 and 30% (w/v).

The amount of extract used in the processes described herein, as well as the amount of metal salts, is sufficient to convert substantially all dissolved and/or mixed metal ions into nanoparticles.

In one embodiment of the invention, the solution of a first metallic salt is mixed with the extract of a plant material in a volumetric ratio of between 2:1 and 10:1, respectively. In a preferred embodiment, said volumetric ratio is 5:1, respectively.

In another optional embodiment one or more surfactants are added to the plant material extract, which are selected from anionic, nonionic, cationic and/or amphoteric surfactants and without limitation, are particularly selected from polysorbate 80, polysorbate 20, glutaraldehyde, second generation quaternary ammoniums and sodium lauryl ester sulfate.

The one or more surfactants are in a concentration between 0.05 and 30% (w/v), preferably between 3 and 10% (w/v).

The reaction time of step a) is at least 2 hours, preferably, 2 hours; a temperature between 25 and 100° C., preferably between 50 and 65° C.; agitation between 800 rpm and 3600 rpm, preferably 800 rpm; and a pH comprising the range between 4 and 12, preferably 8 and 11.

In stage a) nucleation process takes place, which for the purposes of the present invention consists in that once the metal salt corresponding to the zerovalent metal atom is reduced, the concentration of the building units reaches the saturation level, producing the first stable solid entities acting as nucleation centers (primary particles), thus giving rise to continuous growth; this depends on the supply of atoms that occurs in the reaction until equilibrium is reached.

The nucleation stage must be short to obtain homogeneous particles in shape and size and this stage depends clearly on the salt/solvent ratio, temperature, and pH. For this reason, it is of primary importance to control these variables.

Once the nanoparticle preparation process is completed, the nanoparticles are left to stand (room temperature and without agitation) for at least two hours, according to step b). As soon as the rest begins, a sample of the supernatant is taken to measure the initial absorbance and identify the nucleation process. After the two hours, the sample is taken to the spectrophotometer to be analyzed a sample of the supernatant, this reading in the spectrum is done during the appropriate hours until a change of ±5% in the absorbance read from the beginning of the nucleation process (formation of particles by the continuous union of atoms) is no longer appreciated. Once the absorbance shows no variation, the reaction is known to be complete. From now on, daily readings will be taken on the spectrum to evaluate the stability of the nanoparticle solution over time.

The metallic nanoparticles of the present invention obtained through the aforementioned method are mono- or bimetallic and comprise the reduced metal or oxides thereof, but may include other components, e.g., other reducing or non-reducing compounds from the same extract of the plants used, conjugated or not with the metals.

In one embodiment, the nanoparticles may be of the metal and/or oxide of any of the salts involved in the process of the invention or combinations thereof. Preferably, the metal nanoparticle may be an iron nanoparticle, a gold nanoparticle, a platinum nanoparticle, a copper nanoparticle, an indium nanoparticle, a silver nanoparticle, a nanoparticle of any of the salts involved in the process of the invention or combinations thereof.

The metal nanoparticles may have a zero valence or some oxidation state. However, nanoparticles synthesized by means of the method of this invention may have different surface charges which depend on the biomolecular components of the extract that are associated with the nanoparticle.

The use of extracts from different parts of plants such as fruits, seeds, leaves, and flowers, are used as agents and/or stabilizers for the green synthesis of nanoparticles, but not all plant species present the same chemotypes, e.g., there are materials containing more flavonoids and phenolic acids that act as metal ion reducers. On the other hand, there are those that present stabilizing agents such as cyclodextrins, used to stabilize copper or silver nanoparticles, individual and hybrid, in addition to controlling the growth and stabilization of nanoparticles from air oxidation.

In conclusion, the activity carried out by the colloidal suspension of nanoparticles depends on the chemotype used in the synthesis.

Additionally, among the most influential parameters in the synthesis of metal nanoparticles or metal oxides are the concentration of the precursor salt, the concentration and reducing power of the extracts, the reaction time, agitation, temperature, and pH, where a change in these variables can affect the morphology of the metal nanoparticles, leading to changes that can be significant in their properties.

During the development of the method in this invention, the colloidal suspension of nanoparticles was not stable, since as time passed, two phases were generated, which was an indication of microparticle formation during synthesis. In this regard, the ranges of the variables affecting the synthesis of the nanoparticles were varied, mainly:
Temperature: in addition to the stabilization of the colloidal suspension, this variable increases the reaction rate, generating more or less nanoparticles in a predetermined reaction time.
pH: in addition to the stabilization of the colloidal suspension, the pH of the reaction medium plays an important role during the formation of nanoparticles, since adequate ranges improve the reducing and stabilizing capacity of the antioxidant compounds in the extract, in addition to presenting more or less absorbance, which is linked to the concentration of nanoparticles.
Salt concentration: in addition to the stabilization of the colloidal suspension, the salt concentration can lead to an increase in the particle sizes of the nanoparticles, due to the agglomeration of these atoms, thus generating microparticles instead of nanoparticles.

Additionally, the method of green synthesis of nanoparticles developed by the present invention allows the elimination of steps known to the prior art, such as centrifugation. Due to the use of polymer in the biocidal composition and the control of the appropriate variables in the green synthesis process of the nanoparticles employed, a two-phase separation of the nanoparticle suspension is not generated, as was previously observed at the end of the reaction, so the centrifugation process was necessary.

### EXAMPLES

### Example 1. Synthesis of Copper-Silver (Cu—Ag) Metal Nanoparticles from Passiflora ligularis

The precursor agent used was the metal salt CuSO₄.5H₂O (copper sulfate pentahydrate) and as reducing agent, the extract of the leaves of Passiflora ligularis species.

For the extract preparation, a pre-treatment was carried out on the Passiflora ligularis, in which the leaf was dried for 7 days in a dark room. It was then ground in a roller mill to a particle size of less than 0.358 mm. Deionized water was added in a liquid/solid ratio of 2:1 (mL deionized water:grams of dry leaf), i.e., twice the volume of deionized water per gram of dry leaf and allowed to stand for 2 hours (this process is called swelling).

Then, enough deionized water was added to this solution to complete a liquid/solid ratio equal to 12 (mL deionized water/g dry leaf) and finally the pH was adjusted to 4.3 with 1 M citric acid. This mixture was left to stand for 24 h. After this time, the extract was centrifuged at 3000 rpm for 2 min to separate the liquid extract from the solid residue. The supernatant was extracted, and it was filtered through a filter paper with a pore size of 4-12 μm to remove the non-precipitated plant material. Finally, the extract obtained was stored under refrigeration.

For the synthesis reaction, 0.05% (w/v) of polyvinylpyrrolidone was added, then mixed with 69.95% (w/v) of a solution of CuSO₄.5H₂O at a concentration of 0.03 M and 30% (w/v) of Passiflora ligularis leaf extract was added (precursor: extract volumetric ratio of 2:1). The mixing was carried out at a temperature of 59±1° C., pH of 9.8±1 and 800 rpm, allowing to obtain a precursor conversion of 99.17% and 7.59 g of macroparticles.

Next, the colloidal solution of nanoparticles obtained is taken to UV-Vis spectrophotometry to carry out the scanning and obtain the absorbances corresponding to different wavelengths. This process is carried out until the absorbance change has an uncertainty degree of ±5% in the sample scanning. The absorbance peak suitable for copper nanoparticles is in the wavelength range of 250 to 400 nm.

### Example 2. Synthesis of Copper-Silver (Cu—Ag) Metal Nanoparticles from Passiflora ligularis

A similar procedure to Example 1 was carried out using CuSO₄.5H₂O (copper sulfate pentahydrate) as precursor agent and additionally AgNO₃ (silver nitrate), and Passiflora ligularis species fruit peel extract as reducing agent.

For pre-treatment of the plant material, the husk was dried for 7 days in a dark room. It was then ground in a roller mill to a particle size between 0.3-0.4 mm. Deionized water was added in a liquid/solid ratio of 3:1 (mL deionized water:g of dried peel), i.e., three times the volume of deionized water per gram of dried peel and allowed to stand for 2 to 3 hours (this process is called swelling).

For the preparation of the extract, sufficient deionized water was added to complete a liquid/solid ratio of 15:1 (mL deionized water/g dry peel) and finally the pH was adjusted to 5 with 1 M citric acid. This mixture was allowed to stand for 24 h. After this time, the extract was centrifuged at 2500 rpm for 5 min. The supernatant was extracted, and it was filtered with a filter paper with a pore size of 4-12 μm to remove the non-precipitated plant material. Finally, the extract obtained was stored under refrigeration.

Finally, 0.05% (w/v) polyvinylpyrrolidone was added, then mixed with 69.95% (w/v) CuSO₄.5H₂O solution at a concentration of 0.015M and 0.015M AgNO₃ to make the metal nanoparticles. Then, 30% (w/v) Passiflora ligularis fruit peel extract was added. The mixture was stirred at a temperature of 57° C.±1° C., pH of 10.5±1 and precursor/extract volumetric ratio of 2:1, respectively, and agitation of 800 rpm which allow obtaining a precursor conversion of 98% and 9 g of macroparticles.

After this, the colloidal solution of nanoparticles obtained is taken to UV-Vis spectrophotometry to carry out the scanning and obtain the corresponding absorbances at different wavelengths. This process is carried out until the absorbance change has an uncertainty degree of ±5% in the scanning of the sample. The absorbance peak suitable for copper-silver nanoparticles is in the wavelength range of 400 to 500 nm.

### Example 3. Synthesis of Copper (Cu) Metal Nanoparticles from Solanum betaceum

The metal salt CuSO₄.5H₂O (copper sulfate pentahydrate) was used as a precursor agent and Solanum betaceum fruit pulp extract was used as a reducing agent.

The Solanum betaceum fruit pulp was pre-treated by grinding it to a puree consistency. Then, it was dried in an oven at 60° C. for 24 hours and re-grinded in a roller mill to a particle size between 0.3 and 0.4 nm. Deionized water was added in a 4:1 ratio (mL deionized water:grams of dry pulp) and allowed to stand for 2-3 hours.

Subsequently, sufficient deionized water was added to complete a 20:1 liquid/solid ratio (mL deionized water:grams of dry pulp) and finally the pH was adjusted to 10 with NaOH. This mixture was left to stand for 24 hours. After this time, the solid phase was separated from the liquid phase by centrifugation at 2500 rpm for 30 min. The supernatant was extracted, and it was filtered with filter paper with a pore size of 4-12 μm to remove the non-precipitated material. Finally, the extract obtained was stored under refrigeration.

For the synthesis reaction, 0.5% (w/v) of polyvinylpyrrolidone was added, then mixed with 81% (w/v) of a solution of CuSO₄.5H₂O at a concentration of 0.015 M. Then, 15.5% (w/v) Solanum betaceum fruit pulp extract and 3% (w/v) polysorbate were added. The optimum values of the process variables for this reaction are: temperature of 60° C., pH 9, precursor/extract volumetric ratio of 5:1, and agitation of 800 rpm.

Next, the colloidal solution of nanoparticles obtained is taken to UV-Vis spectrophotometry to carry out the scanning and obtain the corresponding absorbances at different wavelengths. This process is carried out until the absorbance change has an uncertainty degree of ±5% in the scanning of the sample. The absorbance peak suitable for copper nanoparticles is in the wavelength range of 250 to 400 nm.

### Example 4. Synthesis of Silver (Ag) Metal Nanoparticles from Passiflora ligularis

The metal salt Ag₂SO₄ (silver sulfate) was used as a precursor agent and Passiflora ligularis species fruit peel extract was used as a reducing agent.

The Passiflora ligularis peel was reduced in size. It was then dried in an oven at a temperature of 60° C. for 24 hours, after which it was ground in a roller mill to a particle size between 0.3 and 0.4 nm. Deionized water was added in a 4:1 ratio (mL deionized water:g of dried peel) and allowed to stand for 2-3 hours.

Then, sufficient deionized water was added to complete a 21:1 liquid/solid ratio (mL deionized water:grams of dry shell) and finally the pH was adjusted to 7 with NaOH. This mixture was left to stand for 24 hours. After this time, the solid phase was separated from the liquid phase using a centrifuge at 2500 rpm for 30 min. The supernatant was extracted to remove the non-precipitated material, it was filtered with filter paper with a pore size of 4-12 μm. Finally, the extract obtained was stored under refrigeration.

For the synthesis reaction, 0.05% (w/v) polyvinylpyrrolidone was added, then mixed with 81.45% (w/v) Ag₂SO₄ solution at a concentration of 0.01M. Then, 15.5% (w/v) Passiflora ligularis peel extract and 3% (w/v) polysorbate were added. The optimum values of the process variables for this reaction are: temperature of 60° C., pH 12, precursor/extract volumetric ratio of 5:1, and agitation of 800 rpm.

Then the colloidal solution of nanoparticles obtained is taken to UV-Vis spectrophotometry to carry out the scanning and obtain the absorbances corresponding to different wavelengths. This process is carried out until the absorbance change has an uncertainty degree of ±5% of the sample. The absorbance peak suitable for silver nanoparticles is in the wavelength range of 400 to 500 nm.

### Example 5. Synthesis of Zinc (Zn) Metal Nanoparticles from Selenicereus megalanthus

The metal salt ZnC₄H₆O₄ (zinc acetate) was used as precursor agent and the fruit pulp extract of Selenicereus megalanthus species was used as reducing agent.

The pulp of the Selenicereus megalanthus fruit was ground to a puree. It was then dried in an oven at 60° C. for 24 hours, after which it was ground in a roller mill to a particle size between 0.3 and 0.4 nm. Deionized water was added in a 4:1 ratio (mL deionized water:grams of dry pulp) and allowed to stand for 2-3 hours.

Next, sufficient deionized water was added to complete a 21:1 liquid/solid ratio (mL deionized water:grams of dry pulp) and finally the pH was adjusted to 7 with NaOH. This mixture was left to stand for 24 hours. After this time, the solid phase was separated from the liquid phase using a centrifuge at 2500 rpm for 30 min. The supernatant was extracted, and it was filtered with filter paper with a pore size of 4-12 μm to remove the non-precipitated material. Finally, the extract obtained was stored under refrigeration.

For the synthesis reaction, 0.05% (w/v) of grenetin was added, then mixed with 81.45% (w/v) of ZnC₄H₆O₄ solution at a concentration of 0.03M. Then, 15.5% (w/v) Selenicereus megalanthus fruit pulp extract and 3% (w/v) polysorbate were added. The optimum values of the process variables for this reaction are: temperature of 60° C., pH 8, precursor/extract volumetric ratio of 5:1, and agitation of 800 rpm.

Then the colloidal solution of nanoparticles obtained is taken to UV-Vis spectrophotometry to carry out the scanning and obtain the corresponding absorbances at different wavelengths. This process is carried out until the absorbance change has an uncertainty degree of ±5% in the scanning of the sample. The absorbance peak suitable for Zinc nanoparticles is presented in a wavelength range of 250 to 350 nm.

### Example 6. Synthesis of Copper-Silver (Cu—Ag) Metal Nanoparticles from Cucurbita moschata

The precursor agent used was the metal salt CuSO₄.5H₂O (copper sulfate pentahydrate) and AgNO₃ (silver nitrate) and as reducing agent the extract of fruit pulp of Cucurbita moschata species.

The pulp of the Cucurbita moschata fruit was ground to a puree. It was then dried in an oven at 60° C. for 24 hours, after which it was ground in a roller mill to a particle size between 0.3 and 0.4 nm. Deionized water was added in a 4:1 ratio (mL deionized water:grams of dry pulp) and allowed to stand for 2-3 hours.

Next, sufficient deionized water was added to complete a 20:1 liquid/solid ratio (mL deionized water:grams of dry pulp) and finally the pH was adjusted to 7 with NaOH. This mixture was left to stand for 24 hours. After this time, the solid phase was separated from the liquid phase using a centrifuge at 2500 rpm for 30 min. The supernatant was extracted, and it was filtered with filter paper with a pore size of 4-12 μm to remove the non-precipitated material. Finally, the extract obtained was stored under refrigeration.

For the synthesis reaction, 0.6% (w/v) polyvinylpyrrolidone was added, mixed with 60.9% (w/v) CuSO₄.5H₂O solution at 0.015M concentration and 20.5% AgNO₃ solution at 0.015 M concentration. Then, 15% (w/v) Cucurbita moschata pulp extract and 3% (w/v) polysorbate were added to the mixtures of the salts prepared above. The optimum values of the process variables for this reaction are: temperature of 60° C., pH 8, precursor/extract volumetric ratio of 4:1 and agitation of 800 rpm.

Then the colloidal solution of nanoparticles obtained is taken to UV-Vis spectrophotometry to carry out the scanning and obtain the corresponding absorbances at different wavelengths. This process is carried out until the absorbance change has an uncertainty degree of ±5% in the scanning of the sample. The absorbance peak suitable for copper-silver nanoparticles are presented in a wavelength range of 400 to 500 nm.

### Example 7. Synthesis of Iron (Fe) Metal Nanoparticles from Alibertia patinoi

The metal salt FeSO₄ (iron sulfate) was used as a precursor agent and the fruit pulp extract of Alibertia patinoi species was used as a reducing agent.

The fruit pulp was ground to a puree. It was then dried in an oven at 60° C. for 24 hours, after which it was ground in a roller mill to a particle size between 0.3 and 0.4 nm. Deionized water was added in a 4:1 ratio (mL deionized water:grams of dry pulp) and allowed to stand for 2-3 hours.

Next, sufficient deionized water was added to complete a 20:1 liquid/solid ratio (mL deionized water:grams of dry pulp) and finally the pH was adjusted to 7 with NaOH. This mixture was left to stand for 24 hours. After this time, the solid phase was separated from the liquid phase using a centrifuge at 2500 rpm for 30 min. The supernatant was extracted, and it was filtered with filter paper with a pore size of 4-12 μm to remove the non-precipitated material. Finally, the extract obtained was stored under refrigeration.

For the synthesis reaction, 0.05% (w/v) of xanthan gum was added and mixed with 82.05% (w/v) of FeSO solution₄ at a concentration of 0.02M. 14.9% (w/v) Alibertia fruit pulp extract and 3% (w/v) polysorbate were added. The optimum values of the process variables for this reaction are: temperature of 50° C., pH 8, precursor/extract volumetric ratio of 5:1, and agitation of 800 rpm.

Then the colloidal solution of nanoparticles obtained is taken to UV-Vis spectrophotometry to carry out the scanning and obtain the corresponding absorbances at different wavelengths. This process is carried out until the absorbance change has an uncertainty degree of ±5% in the scanning of the sample. The absorbance peak suitable for iron nanoparticles is in the wavelength range of 300 to 400 nm.

### Example 8. Synthesis of Metallic Copper (Cu) Nanoparticles from Cucurbita moschata

The metal salt CuSO₄.5H₂O (copper sulfate pentahydrate) was used as precursor agent and the fruit pulp extract of Cucurbita moschata species was used as reducing agent.

The pulp of the Cucurbita moschata fruit was ground to a puree. It was then dried in an oven at 60° C. for 24 hours, after which it was ground in a roller mill to a particle size between 0.3 and 0.4 nm. Deionized water was added in a 4:1 ratio (mL deionized water:grams of dry pulp) and allowed to stand for 2-3 hours.

Next, sufficient deionized water was added to complete a 20:1 liquid/solid ratio (mL deionized water:grams of dry pulp) and finally the pH was adjusted to 7 with NaOH. This mixture was left to stand for 24 hours. After this time, the solid phase was separated from the liquid phase using a centrifuge at 2500 rpm for 30 min. The supernatant was extracted, and it was filtered with filter paper with a pore size of 4-12 μm to remove the non-precipitated material. Finally, the extract obtained was stored under refrigeration.

For the synthesis reaction, 0.05% (w/v) polyvinylpyrrolidone was added, then mixed with 88.02% (w/v) CuSO₄.5H₂O solution at a concentration of 0.01M. 8.93% (w/v) Cucurbita moschata fruit pulp extract and 3% (w/v) polysorbate were added. The optimum values of the process variables for this reaction are: temperature of 50° C., pH 10, volumetric ratio of precursor/extract between 10:1, respectively and agitation of 800 rpm.

Next, the colloidal solution of nanoparticles obtained is taken to UV-Vis spectrophotometry to carry out the scanning and obtain the corresponding absorbances at different wavelengths. This process is carried out until the absorbance change has an uncertainty degree of ±5% in the scanning of the sample. The absorbance peak suitable for copper nanoparticles occurs in a wavelength range from 250 to 400 nm.

### Example 9. Characterization of Colloidal Nanoparticle Solution

There are different physicochemical characterization techniques that are helpful and can be used as a qualitative and/or quantitative guide for the identification and determination of candidate extracts capable of reducing metal ions from metal salts that facilitate the synthesis of metal nanoparticles. These techniques are called Reductive Power or Antioxidant Capacity Tests. Among the most prominent are the ferric reducing antioxidant power (FRAP), the total radical trapping antioxidant parameter (TRAP), the Trollox equivalent antioxidant capacity assay (TEAC), DPPH radical trapping capacity, ABTS radical trapping capacity, Fe(III) reduction antioxidant power, among others. These methods have been previously used to document the reducing power of a variety of plants, plant parts, and plant products.

The reduction capacity or power of a plant may vary according to the level of antioxidant biomolecules present. The results of these tests may change according to the conditions and/or areas of cultivation, harvesting, and according to the plant species.

The production of nanoparticles can be confirmed by different characterization techniques. Each of them provides information of vital relevance to the invention. Nanoparticle production can be confirmed by analysis of the surface plasmon resonance using a UV-Vis spectrophotometer in the range of 200 to 600 nm. By using an X-ray diffractometer (XDR), the valence of the nanoparticles can be determined. The size distribution of the nanoparticles can be evaluated by Dynamic Light Scattering (DLS). The morphology of the nanoparticles can be determined by Scanning Optical Microscopy (SEM) or Transmission Electron Microscopy (TEM). A Fourier Transform Infrared Spectrophotometer (FTIR) can be used to evaluate and determine the composition of the obtained solution.

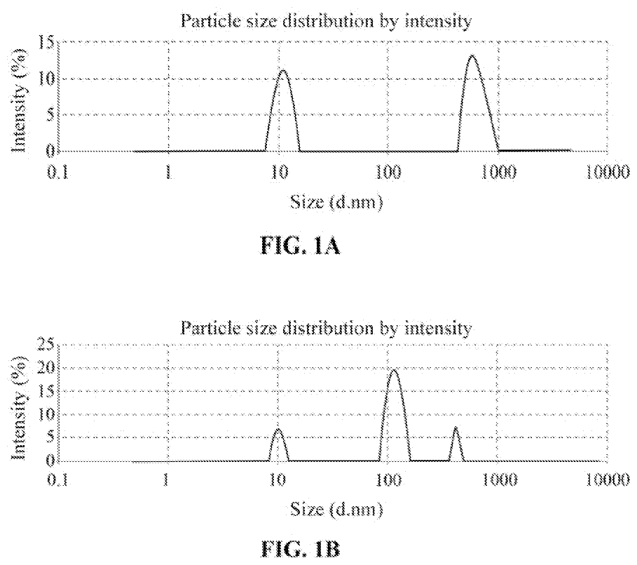

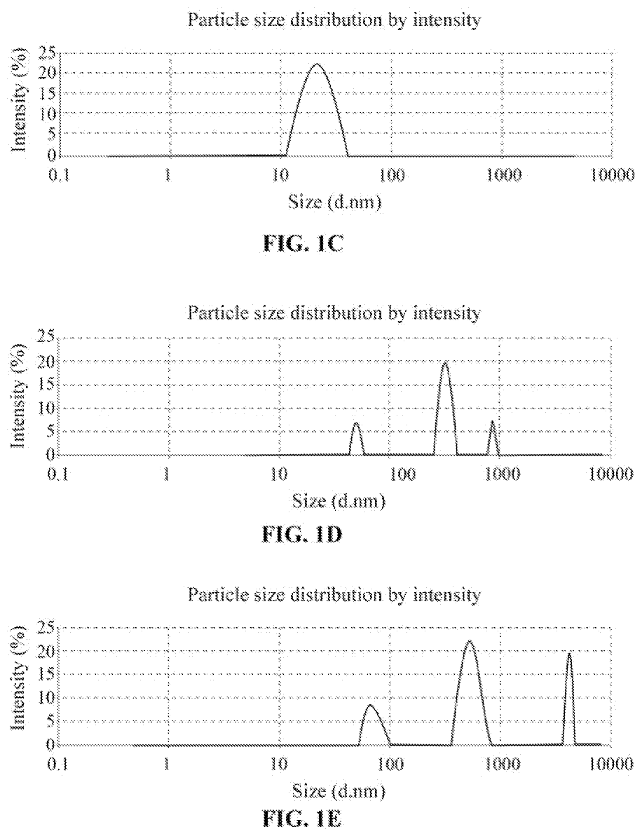

In this regard, the nanoparticle solution of Example 2 was characterized by Dynamic Light Scattering (DLS). FIG. 1A shows the particle size distribution, where the first peak on the left represents 56.2% of the total nanoparticles, which are found with a size of 11.97±3.197 nm, while the second peak shows the missing 43.6% found with a particle size of 755 nm. With this result, the generation of nanoparticles is verified.

Likewise, the solution of Example 3 was characterized. FIG. 1B shows that the first peak on the left represents 20.1% of the total nanoparticles, which are found with a particle size of 10±3 nm; the second peak represents 60% of the total nanoparticles, which are found with a particle size 190±3.01 nm and the last peak which represents 19.9% of the total nanoparticles, with particle sizes of 730 nm.

On the other hand, FIG. 1C shows that the entire solution of Example 6 has a nanoparticle size of 46±5.8 nm.

FIG. 1D shows that the solution of Example 7 has 3 peaks, the first peak on the left represents 20.1% of the total nanoparticles which are found to be 86±3 nm in size, the second peak represents 60% of the total nanoparticles which are found to be 720±2.01 nm in particle size, and the last peak which represents 19.9% of the total nanoparticles are found to be 990±5.02 nm in particle size.

Finally, the solution of Example 5, FIG. 1E shows that the first peak on the left represents 15% of the total nanoparticles, which are found with a size of 90±4.01 nm; the second peak represents 45% of the total nanoparticles, which are found with a particle size 900±2.01 nm; and the last peak represents 40% of the total nanoparticles, with particle sizes of 7000±5.02 nm.

In addition, the nanoparticle solution obtained in Example 2 was characterized by a Fourier Transform Infrared Spectrophotometer (FTIR), where the presence of copper oxides is evidenced, due to the peaks in bands between 550 and 1083 cm⁻¹ (Raul et al., 2014), and the presence of secondary alcohols and polyphenols due to the peaks observed in bands near 1375 cm⁻¹ (Nasrollahzadeh, Sajadi, Rostami-Vartooni, & Hussin, 2016). Therefore, it can be stated that the sample contains significant amount of copper oxides (CuO and Cu₂O) and organic compounds (polyols and polyphenols) that can help to stabilize the NPs in the colloidal solution (flame et al., 2012).

Likewise, the UV-visible spectrum of copper, silver, iron, copper-silver nanoparticles synthesized by plant extracts from the pulp of Solanum betaceum with and without surfactant, Pasiflora ligularis peel, Alibertia patinoi, Selenicereus megalanthus pulp, Cucurbita moschata was analyzed, pulp of Selenicereus megalanthus, Cucurbita moschata, where the presence of nanoparticles is evident, since the absorbance is found in the different wavelengths suitable for each synthesized nanoparticle, according to the values reported in the literature. Silver nanoparticles are found between a range of 400 nm and 500 nm, copper nanoparticles between 250 nm and 400 nm, zinc nanoparticles between 250 nm and 350 nm. The fact that the nanoparticles emit in that range is because the metal with zero valence emits in the ranges specified above.

Likewise, the samples of the colloidal solution of nanoparticles obtained in Examples 1 to 8 were analyzed by TEM transmission electron microscopy, which exhibited different shapes that depended on the parameters used in the synthesis method described. It could be evidenced that those samples that had a pH higher than 10 and temperature above 50° C. yielded spherical and rod shapes, while for a pH below this, the nanoparticles had triangular or polygonal shapes.

On the other hand, the influence of temperature allowed obtaining small variations in the average crystalline size of the nanoparticles. On the other hand, the concentration of the added extract modifies the size of the nanoparticles, since the higher the extract, the smaller the size of the nanoparticles.

### Example 10. Biocidal Composition of Copper Nanoparticles

Once the copper nanoparticles were synthesized, a composition with biocidal activity was prepared. In a stirred tank in discontinuous operation, polysorbate 20 was added at a concentration of 3.6% (w/v), followed by the addition of hydropropyl cellulose at 0.2% (w/v), agitation at 1000 rpm was started, then pH was adjusted to 4 and 0.05% (w/v) of a colloidal solution of copper nanoparticles was slowly added, followed by the addition of 10% (w/v) of Solanum betaceum plant extract, this solution was kept in agitation for at least 30 min. Finally, deionized water was added, and the pH was adjusted to 8.

### Example 11. Biocidal Composition of Copper-Silver Nanoparticles

In a stirred tank in discontinuous operation, glutaraldehyde was added at a concentration of 5.6% (w/v), then hydroxyethylcellulose was added at 0.2% (w/v), agitation was started at 1000 rpm and 0.05% (w/v) of the colloidal solution of copper-silver nanoparticles was slowly added, followed by the addition of 10% (w/v) of Passiflora ligularis plant extract.

This solution was kept in agitation for at least 30 min; finally, deionized water was added, and the pH was adjusted to 8.

### Example 12. Biocidal Composition of Zinc Nanoparticles

In a stirred tank in discontinuous operation, polysorbate 80 was added at a concentration of 3.6% (w/v), then hydroxyethylcellulose was added at 0.5% (w/v), agitation was started at 1000 rpm and 0.1% (w/v) of the colloidal solution of nanoparticles was slowly added. Next, 15% (w/v) of Selenicereus megalanthus plant extract was added, this solution was kept in agitation for at least 30 min, finally, deionized water was added, and the pH was adjusted to 8.

### Example 13. Biocidal Composition of Iron Nanoparticles

In an agitated tank in discontinuous operation, fifth generation quaternary ammonium was added at a concentration of 3.6% (w/v), then 0.5% (w/v) grenetin was added, agitation was started at 1000 rpm, the pH was adjusted to 4 and 0.8% (w/v) of the colloidal solution of nanoparticles was slowly added; then 15% (w/v) of Alibertia patinoi plant extract was added. This solution should be kept in agitation for at least 30 min, finally, deionized water was added, and the pH was adjusted to 8.

### Example 14. Biocidal Activity Exhibited by Copper and Silver Nanoparticles

For the copper and silver nanoparticles prepared in Examples 1, 2, and 4, microbiological and virucidal tests were carried out using the bacterial strains Escherichia coli, Salmonella typhimurium, Staphylococcus aureus and Desulfotomaculum nigrificans, the fungal strains Candida albicans and Aspergillus niger, and Dengue flavivirus.

The results are shown in the following table:

TABLE 1
Minimum Bactericidal Concentration (MBC)
and biocidal activity of copper and silver nanoparticles
synthesized from Passiflora ligularis.

| | Culture result | MBC |
|---|---|---|
| STRAIN | 3 × 10⁵ (CFU) | (μg/ml) |
| Escherichia coli | Negative | 10.5 |
| Salmonella typhimurium | Negative | 10.5 |
| Staphylococcus aureus | Negative | 10.5 |
| Desulfotomaculum nigrificans | Negative | 4.25 |
| Candida albicans | Negative | 10.5 |
| Aspergillus niger | Negative | 10.5 |
| Dengue flavivirus | Negative | — |

### Example 15. Biocidal Activity Exhibited by Silver, Copper, Copper-Silver, Copper-Silver and Zinc Nanoparticle Compositions

The biological activity and effectiveness of the biocidal composition developed in Examples 10 to 13 were quantified in terms of the minimum inhibitory concentration (MIC) by carrying out the procedure described below:

Escherichia coli (ATCC® 25922), donated by the University of Santander, was used, suspended in saline and glycerol solution (40%-Panreac) and preserved at 80° C. For reactivation, two passages were carried out in nutrient agar (Merck).

The method standardized by the Clinical Laboratory Standards Institute, CLSI M07-A10, was used. A bacterial suspension of 3-5 colonies was prepared from a fresh culture of the microorganism, adjusting its concentration to 0.5 turbidity on the McFarland scale in saline solution (0.85%); subsequently, a 1:50 dilution was made and from this 1:20 in Mueller Hinton broth, adjusting to a final concentration of 1 or 2×10⁴ cells/ml. The inoculum was exposed to different concentrations of copper, silver and zinc nanoparticles synthesized in plant extracts for 24 hours at 35° C.

As positive controls, chlorhexidine was used as a reference disinfectant, starting from a concentration of 4% (w/v). This method made it possible to determine the minimum concentration capable of inhibiting microbial growth by the metal nanoparticles, by means of macroscopic assessments of the turbidity associated with microbial growth.

In order to determine the minimum bactericidal concentration, it was taken from the MIC. Ten μl of each of the concentrations at which visible growth inhibition of the microorganism was observed, were taken and then sown in Petri dishes with Mueller Hinton agar incubated at 35° C. for 24 hours, considering as bactericidal that concentration at which a number of <3 colony forming units (CFU) was observed.

TABLE 2
Minimum inhibitory concentration (MIC) and biocidal activity
of silver, copper, copper-silver, and zinc compositions.

| | | Result 3 × 10⁵ | MIC |
|---|---|---|---|
| Plant Species | Nanoparticles | CFU/ml | (μg/ml) |
| Solarium betaceum | Silver | Negative | 5.05 ± 0.07 |
| | Copper | Negative | 8.05 ± 0.02 |
| | Copper - silver | Negative | 6.10 ± 0.01 |
| Passiflora ligularis | Silver | Negative | 6.05 ± 0.03 |
| | Copper | Negative | 9.05 ± 0.07 |
| | Zinc | Negative | 7.10 ± 0.03 |
| | Copper - silver | Negative | 10.5 ± 0.05 |
| Alibertia patinoi | Silver | Negative | 4.05 ± 0.04 |
| | Copper | Negative | 6.20 ± 0.06 |
| | Zinc | Negative | 5.60 ± 0.08 |
| | Copper - silver | Negative | 5.20 ± 0.01 |
| | Silver - zinc | Negative | 9.10 ± 0.03 |
| Selenicereus megalanthus | Silver | Negative | 5.09 ± 0.02 |
| | Copper | Negative | 8.05 ± 0.05 |
| | Zinc | Negative | 12.05 ± 0.04 |
| | Copper - silver | Negative | 6.10 ± 0.07 |
| Cucurbita moschata | Silver | Negative | 5.05 ± 0.08 |
| | Copper | Negative | 7.05 ± 0.04 |
| | Zinc | Negative | 6.10 ± 0.05 |
| | Copper - zinc | Negative | 7.05 ± 0.02 |
| | Copper - silver | Negative | 4.05 ± 0.04 |
| | Silver - zinc | Negative | 6.10 ± 0.02 |

### Example 16. Effectiveness Testing of Nanoparticle Compositions

For the biocidal compositions developed in Examples 10 to 13, effectiveness tests were carried out with different bacterial strains during a 30-minute contact time between the biocide and the bacterial strain. The bacterial strains used in the biocides were: Escherichia coli, Salmonella typhimurium, Staphylococcus aureus, Desulfotomaculum nigrificans, Candida albicans, Aspergillus niger, and Pseudomonas aeruginosa.

TABLE 3
Biocidal activity of copper, silver, zinc, iron,
and copper-silver nanoparticle compositions

| | Volumetric ratio | Culture result 3*10⁴ |
|---|---|---|
| Bacterial Strain | Crop: biocide | CFU/ml |
| Escherichia coli | 1:5 | Negative |
| Salmonella typhimurium | 1:4 | Negative |
| Staphylococcus aureus | 1:5 | Negative |
| Desulfotomaculum nigrificans | 1:5 | Negative |
| Candida albicans | 1:5 | Negative |
| Aspergillus niger | 1:5 | Negative |
| Pseudpmonas aeruginosas | 1:4 | Negative |

### Example 17. Biocidal Activity of the Composition Comprising Copper Nanoparticles on Desulfovibrio desulfuricans

Biocidal activity was evaluated on Desulfovibrio desulfuricans, by the Time Kill Test method in Starkey medium (maintenance medium). In this methodology the biocidal agent comprising copper nanoparticles was placed in contact with a known population of microorganisms for a certain time at a temperature of 37° C.

Starkey medium is a maintenance medium (used both for inoculum and for dilution and measurement of samples). The preparation of the medium was carried out with the following formulation:

TABLE 4
Starkey medium formulation

| | WEIGHT |
|---|---|
| CONTENTS | (grams) |
| K₂HPO₄ | 0.56 |
| NH₄Cl | 1.1 |
| CaCl₂ | 0.12 |
| Na₂SO₄ | 0.56 |
| MgSO₄* 7 H₂0 | 2.2 |
| Sodium lactate | 3.8 |
| Yeast extract | 0.5 |
| Distilled water | 1000 ml |

Mixing of all elements was carried out and the pH was adjusted to 7.5±0.2 with NaOH 1N and heated to 70° C.

It was dosed in 9.0 ml volumes, one needle was introduced alone, and another connected to the gas system injecting N₂ and displacing oxygen, thus allowing an anaerobic environment, after which it was autoclaved at 121° C. and 15 psi for 15 minutes.

Subsequently, for the preparation of the inoculum, 5 ml of inoculum of the ATCC Desulfovibrio desulfuricans strains were taken in 50 ml of Starkey medium guaranteeing the desired amount of inoculum. It was incubated for 24 hours at 37° C.

For the evaluation of the biocide, 1 ml of the prepared inoculum was taken and added to each of the tubes containing 9 ml of Starkey medium, additionally 200 ppm of the biocide to be evaluated was added and then its absorbance was measured at 600 nm in the TERMO GENESYS 5 equipment at 0 h, 2 h, 4 h, 24 h, 36 h, 72 h, and 192 h.

For the positive control, glutaraldehyde was used, and the same procedure described above for the sample was carried out.

The average of the microbiological counts transformed to logarithm was recorded and the logarithmic reduction of the populations was calculated for each time according to the formula:

log₁₀ RL=log₁₀ ‘Positive control’−log₁₀ ‘Biocide’

Exhibiting the behavior shown in Table 5

TABLE 5
Biocidal activity exhibited by the biocide
with copper nanoparticle composition
Biocidal Activity (RL) (average)
8.05 ± 0.07
5.32 ± 0.02
5.34 ± 0.01
6.65 ± 0.07
15.86 ± 0.33
5.31 ± 0.03
3.67 ± 0.05

From the results obtained in Examples 15 to 17, it is evident that the biocidal activity exhibited by the compositions of the present invention against different strains presents a bacterial count consistently below 3 CFU/ml. This is evidenced in the tables presented above since all the culture counts in scales of 3*10⁵ show negative results, this means that below this number of colonies there is no bacterial growth. Likewise, the tests carried out with the colloidal solution of nanoparticles of Example 14, show inhibition of the strains evaluated.

On the other hand, the results obtained from Dynamic Light Scattering (DLS) confirm the capacity of the different plant extracts studied as reducing agents for the synthesis of metallic and bimetallic nanoparticles.

Finally, it is noted that the addition of different additives such as polymeric thickeners and surfactants help the stability of the colloidal solution of nanoparticles, this is evidenced by the periodic readings of absorbances, in addition to witnessing it qualitatively since only the presence of one phase is observed.

Additionally, the biocidal composition of the present development allows the maximum use of the vegetable extracts since they act in the composition as stabilizing agents that functionalize the nanoparticles, being located on their surface as a type of stabilizing coating, which prevents the nanoparticles from agglomerating and thus avoid the formation of particles. Likewise, the use of surfactants in the composition allows the control of the metallic or metal oxide nanoparticles size. The control of the morphology of the nanoparticles in the biocidal composition of the development is important, since the properties that the compositions can have depend on it, such as catalytic, optical, photonic, chemical, and biological properties, as well as biocidal properties.

On the other hand, Examples 1 to 8 show that there was a considerable reduction in the normal synthesis times of nanoparticles known by a person versed in the matter of 25%, also the pH used to carry out the reaction corresponds to more basic values of 8 and 12, in addition to the incorporation of polymer since this helps in the reduction of agglomerates, which is favorable for different properties such as size, stability, and biocidal activity.

1. A biocidal composition comprising:
metal or metal oxide nanoparticles;
a vegetable extract;
wherein the metal of the nanoparticles is selected from the group of transition metals, XIII and XIV; and
wherein the plant extract is selected from an extract of Passiflora ligularis, Sambucus mexicana, Selenicereus megalanthus, Solanum quitoense, Annona cherimola, Solanum bataceum, Cucurbita moschata, Luffa aegyptiaca, Arracacia xanthorrhiza, Fragaria ananassa, Furcraea andina, Alibertia patinoi, Pourteria sapota, Ficus carica, Passiflora quadrangularis, Vaccinium meridionale, Passiflora maliformis, Bactris gasipaes, Cassia grandis, Vasconcellea pubescens, Melicoccus bijugatus, and Mammea americana.

2. The composition of claim 1, wherein the size of the nanoparticles is less than 100 nm.

3. The composition of claim 1, further comprising a polymeric thickener and a surfactant.

4. A method for in situ production of metal nanoparticles comprising:
a) mixing a polymeric thickener at a concentration between 0.05 and 5% (w/v), a solution of a first metal salt at a concentration between 0.05M and 10M, and an extract of a plant material at a volumetric ratio of the first metal salt:extract between 2:1 and 10:1, for at least 2 hours, an agitation of at least 800 rpm, at a temperature between 25 and 100° C. and a pH between 4 and 12;
b) letting the mixture of step a) stand for at least 2 hours at room temperature and without stirring;
c) taking readings of the mixture in a spectrophotometer at the end of step b), until the absorbance does not show variation;
wherein the plant material of the extract is selected from the group consisting of Passiflora ligularis, Sambucus mexicana, Selenicereus megalanthus, Solanum quitoense, Annona cherimola, Solanum bataceum, Cucurbita moschata, Luffa aegyptiaca, Arracacia xanthorrhiza, Fragaria ananassa, Furcraea andina, Alibertia patinoi, Pourteria sapota, Ficus carica, Passiflora quadrangularis, Vaccinium meridionale, Passiflora maliformis, Bactris gasipaes, Cassia grandis, Vasconcellea pubescens, Melicoccus bijugatus, and Mammea americana.

5. The method of claim 4, wherein the plant extract is aqueous and/or ethanolic.

6. The method of claim 4, wherein the plant extract comprises a surfactant.

7. The method of claim 4, wherein a second metal salt is added simultaneously into the mixture of step a).

8. The method of claim 7, wherein the metal of the first or second salt is selected from the group of transition metals, XIII and XIV.

9. The method of claim 4, wherein the nanoparticles obtained are mono or bimetallic.
